(19) United States
(12) Patent Application Publication
(10) Pub. No.: US 2012/0005518 A1
(43) Pub. Date: Jan. 5, 2012

(54) Host Controller, Semiconductor Device, Information Processing Apparatus, and Sampling Method

(76) Inventors: Noriyo Fujii, Ome-shi (JP); Masayoshi Murayama, Hanno-shi (JP)

(21) Appl. No.: 13/103,774

(22) Filed: May 9, 2011

(30) Foreign Application Priority Data
Jun. 30, 2010 (JP) 2010-150454

(51) Int. Cl. G06F 1/04

(52) U.S. Cl. 713/503

(57) ABSTRACT

According to one embodiment, there is provided a host controller. The host controller includes a plurality of data input sections and a controller. The plurality of data input sections is configured to repeat an operation of acquiring a plurality of values by sampling a content of read data and additional information accompanying the content with a plurality of clocks of different phases. The controller is configured to adjust phases of the clocks based on the plurality of values acquired by the data input sections.

### CROSS-REFERENCE TO RELATED APPLICATIONS

This application is based upon and claims the benefit of priority from Japanese Patent Application No. 2010-150454, filed Jun. 30, 2010; the entire contents of which are incorporated herein by reference.

### FIELD

Embodiments described herein relate generally to a host controller, a semiconductor device, an information processing apparatus, and a sampling method.

### BACKGROUND

Recent secure digital (SD) cards have higher data transfer rates as compared to the conventional SD cards. Therefore, the amount of delay at the time of data reception, which was fixed in the conventional cards, is not fixed, and a phase of a sampling position need be set in the host controller.

Generally, phase setting is carried out by tuning (or calibration), that is, phase adjusting by comparing received data with an expected value before transferring the data.

In another method, a bit phase synchronization circuit generates a plurality of kinds of (e.g., three) clocks of different phases to latch data, and a clock is determined through comparison of the phases with the three items of data, so that bit phase synchronization can be achieved in a short period of time.

However, even if the aforementioned tuning (or calibration) is carried out, if the phase is shifted due to a temperature drift or the like during the data transfer, data (such as read data) cannot correctly be obtained from the memory card. In this case, data transfer must be repeated by retuning at small intervals, which will result in a problem that the data transfer efficiency is lowered.

Furthermore, the conventional art described above determined only one of clocks that are selectable from the comparison result. It cannot be applied to data communications of a high transfer rate, in which the amount of delay at the time of data reception is not fixed.

### BRIEF DESCRIPTION OF THE DRAWINGS

FIG. 1 is a diagram which shows an appearance of a notebook-type personal computer as an information processing apparatus according to an embodiment;

FIG. 2 is a block diagram that shows a schematic configuration of a host controller;

FIG. 3 is a diagram for explaining that not only a content of read data but also additional information, e.g., cyclic redundancy check (CRC) information and an end bit, accompanying the content are sampled;

FIG. 4 is a diagram for explaining sampling with three kinds of sampling clocks (CLK L, CLK C, and CLK R) of different phases;

FIG. 5 is a diagram that shows an example of timings (data acquiring timings) when sampling is carried out with three kinds of sampling clocks (CLK L, CLK C, and CLK R) of different phases;

FIG. 6 is a diagram that shows sampling data values obtained when sampling is carried out at timings shown in FIG. 5;

FIG. 7 is a diagram for explaining conventional art that cannot detect a phase shift when values are all “1”;

FIG. 8 is a diagram for explaining that even if values of a content are the same, a different value can be obtained from CRC information or an end bit;

FIG. 9 is a block diagram showing a first modification of the configuration shown in FIG. 2; and

FIG. 10 is a block diagram showing a second modification of the configuration shown in FIG. 2.

### DETAILED DESCRIPTION

In general, according to one embodiment, there is provided a host controller. The host controller includes a plurality of data input sections and a controller. The plurality of data input sections is configured to repeat an operation of acquiring a plurality of values by sampling a content of read data and additional information accompanying the content with a plurality of clocks of different phases. The controller is configured to adjust phases of the clocks based on the plurality of values acquired by the data input sections.

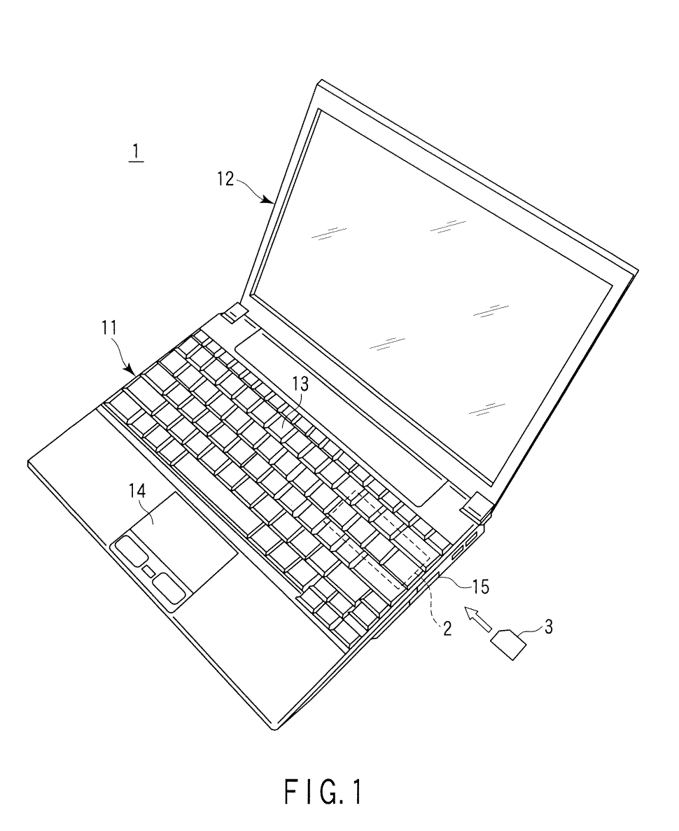

FIG. 1 is a diagram showing an appearance of a notebook-type personal computer (hereinafter referred to the PC 1) as an information processing apparatus according to an embodiment.

The PC 1 includes a main body 11 and a display unit 12. The main body 11 includes a keyboard 13 and a touch pad 14, which is a pointing device. The main body 11 contains in its inside a main circuit board, an SD (Secure Digital) card host controller (herein after referred to simply as “host controller” and to be detailed later), which is indicated by a broken line with a reference numeral 2, an optical disk drive (ODD) unit, an SD card slot, etc.

The SD card slot is provided in a peripheral wall of the main body 11. The peripheral wall has an opening 15 for the SD card slot. The user can insert/remove an SD card 3 into/from the card slot through the opening 15 from/to the outside of the main body 11.

The PC 1 is installed with a host driver, that is, a device driver to control the host controller 2. The host driver and the host controller 2 allow read/write processing and tuning (or calibration processing) of the SD card 3 inserted in the SD card slot.

This embodiment is configured such that the host controller 2 is incorporated in the PC 1. However, the host controller 2 may be incorporated in an SD card reader/writer or the like that is externally attached to the PC 1 via a USB interface or any other interface. The SD card is described as an example of an object to be controlled by the host controller 2 in this embodiment. However, the object to be controlled is not limited to the SD card, but may be any other memory card, in which the amount of delay at the data reception time is not fixed and which requires phase setting of a sampling position.

The information processing apparatus is not limited to the personal computer as described above, but may be a cellular phone, a personal digital assistant (PDA), a digital still camera, a digital video camera, a digital television receiver, etc. The present invention is also applicable to these apparatuses.

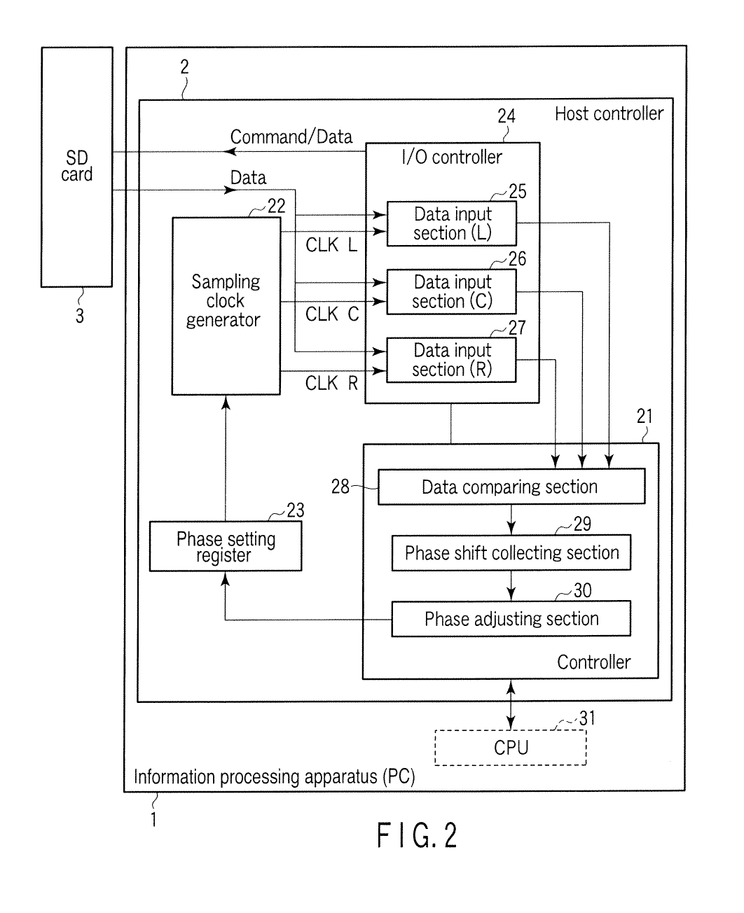

FIG. 2 is a block diagram showing a schematic configuration of the host controller 2.

The host controller 2 can be configured as hardware (a semiconductor device) including an application specific integrated circuit (ASIC) or a field programmable gate array (FPGA).

The host controller 2 is controlled by the host driver executed by a central processing unit (CPU) of the PC 1. A variety of requests from the host driver are transferred to a controller 21 via a system bus interface (not shown) of the controller 21.

A sampling clock generator 22 generates three kinds of sampling clocks (CLK L, CLK C, and CLK R) of different phases according to phase setting in a phase setting register 23 by the controller 21, and supplies them to an I/O controller 24. The sampling clocks are phase-shifted clocks for sampling received data. The sampling clock generator 22 generates sampling clocks such that all phases thereof fall within the range of sampling clock phases which allowed correct reception of data in the previous correction.

The I/O controller 24 transmits to the SD card 3 inserted in the SD card slot a command for the SD card 3 as a command in compliance with a SD bus protocol, and receives data from the SD card 3 (for example, multiple read data). The I/O controller 24 includes a data input section (L) 25, a data input section (C) 26 and a data input section (R) 27, which respectively sample the data received from the SD card 3 in accordance with the three kinds of sampling clocks (CLK L, CLK C, and CLK R) of different phases supplied from the sampling clock generator 22, and transfers the sampled data to the controller 21.

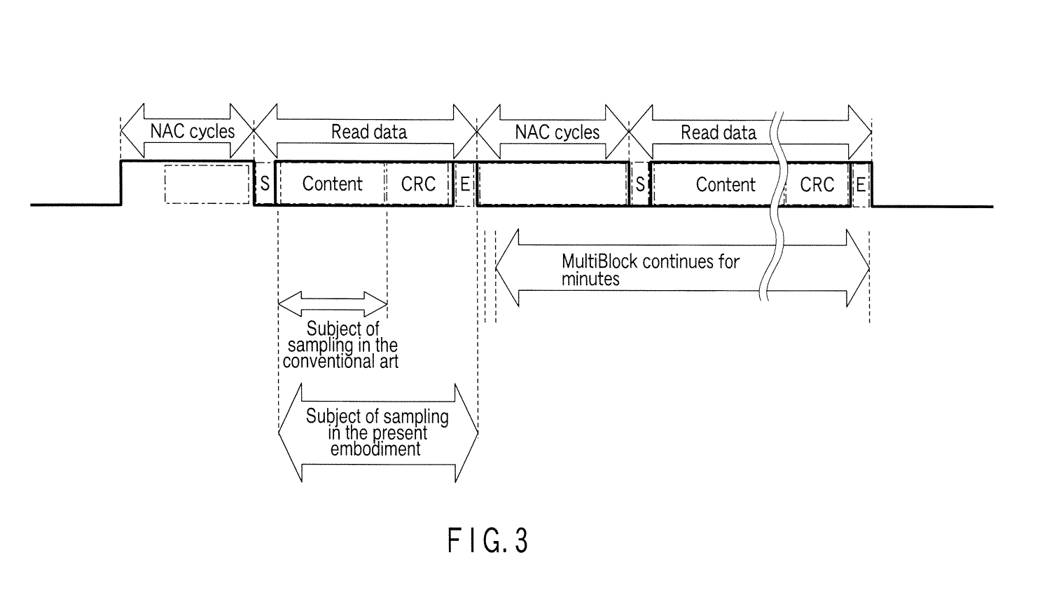

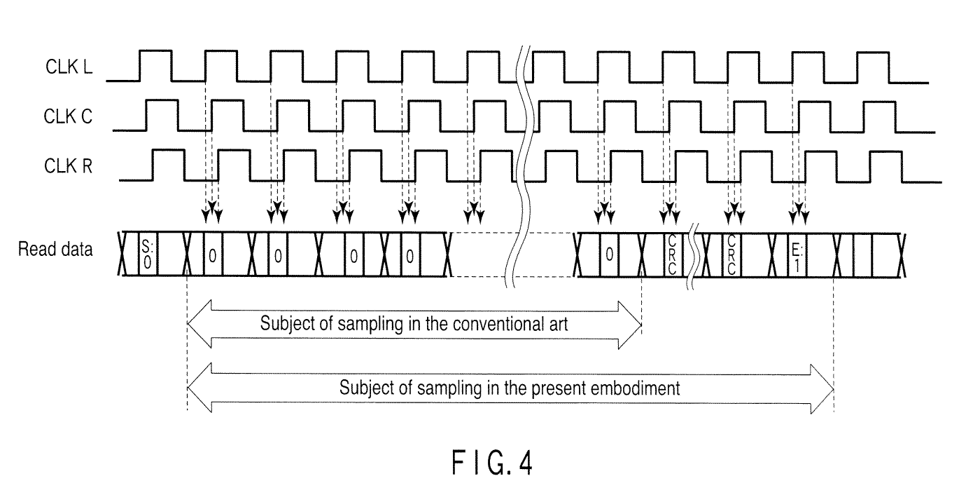

In particular, the I/O controller 24 samples not only a content of read data but also additional information, e.g., cyclic redundancy check (CRC) information and an end bit, accompanying the content, as shown in FIG. 3. Then, the I/O controller 24 repeats operations of acquiring three values by sampling in accordance with the three kinds of sampling clocks (CLK L, CLK C, and CLK R) of different phases, as shown in FIG. 4. The reason why the additional information is also sampled will be described later in detail.

When the CPU 31 of the PC 1 accesses the SD card 3, received data sampled by the data input section (C) 26 is transferred to the CPU 31 of the PC 1 via the system bus interface in the controller 21. The CPU 31 of the PC 1 also functions as control means for controlling the host controller 2 by executing the host driver. In this specification, a set of the CPU 31 and the host driver is called a host side of the host controller 2.

The controller 21 has a function of detecting a shift of data relative to the clocks based on three values respectively obtained by the data input section (L) 25, the data input section (C) 26 and the data input section (R) 27, and adjusting the phases of the clocks based on the detected shift of the data. Thus, the controller 21 has a function of autonomously adjusting the phases of the clocks without receiving any instructions from the host side. Alternatively, the controller 21 may be configured to have two switchable modes: a mode of autonomously adjusting the phases of the clocks and a mode of adjusting the phases of the clocks according to instructions from the host side. The controller 21 includes a data comparing section 28, a phase shift collecting section 29, and a phase adjusting section 30.

The data comparing section 28 compares three values acquired by sampling data in the data input section (L) 25, the data input section (C) 26 and the data input section (R) 27 in units of sampling, and transfers a comparison result (whether the three values match or not etc.) to the phase shift collecting section 29.

The phase shift collecting section 29 collects information relating to the phase shift of data relative to the clocks (whether there is a phase shift or not, the direction of the phase shift, the amount of the phase shift, etc.) based on the comparison result obtained from the data comparing section 28. The result of the collection is transferred to the phase adjusting section 30 and also to the host side.

If there is a phase shift, the phase adjusting section 30 determines a phase shift amount which compensates for the phase shift based on the result of the collection obtained from the phase shift collecting section 29, and sets the amount in the phase setting register (updates the set value).

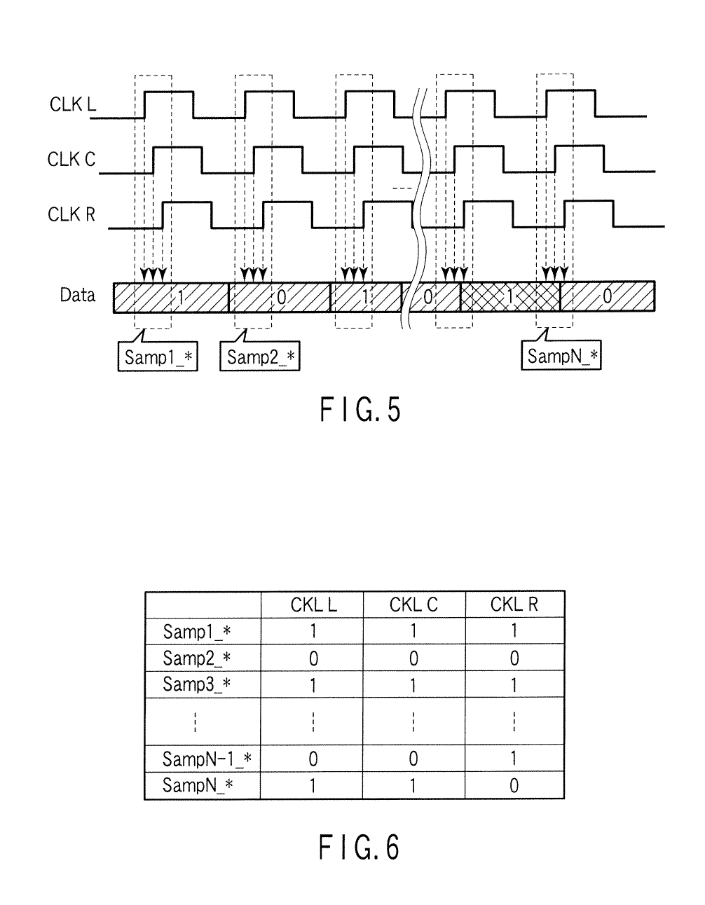

Data sampling and collection of phase shifts using three sampling clocks of different phases will now be described with reference to FIG. 5 and FIG. 6. FIG. 5 is a diagram that shows an example of timings (data acquiring timings) when input data from the SD card 3 are sampled using the three kinds of the sampling clocks (CLK L, CLK C, and CLK R) of different phases. FIG. 6 is a diagram that shows sampling data values obtained when sampling is carried out at timings shown in FIG. 5.

The sampling clock CLK L shown in FIG. 5 lags the base clock CLK C by a predetermined unit in phase, and the sampling clock CLK R leads the base clock CLK C by the predetermined unit in phase (in the following description, the phase of the base clock CLK C is referred to as the center, the phase which lags the base clock CLK C is referred to as the left, and the phase which leads the base clock CLK C is referred to as the right). The results of sequentially sampling data with the three sampling clocks CLK L, CLK C, and CLK R are represented as Samp1_L/Samp1_C/Samp1_R, Samp2_L/Samp2_C/Samp2_R, . . . and SampN_L/SampN_C/SampN_R. In the drawings, the results of sampling with the three sampling clocks at the respective sampling timings are represented as Samp1_*, Samp2_*, and SampN_*.

The sampling data values obtained at the sampling timings shown in FIG. 5 are Samp1_L=1, Samp1_C=1, Samp1_R=1, SampN−1_L=0, SampN−1_C=0, SampN−1_R=1, SampN_L=1, SampN_C=1, SampN_R=0. These values are shown in FIG. 6. In this example, at the two timings corresponding to SampN−1 and SampN, the sampling data values for the three clocks are different. Therefore, it is determined that phase shifts occur and these sampling data are counted as subjects for phase correction.

In this embodiment, not only the content in the read data but also the additional information, e.g., CRC information and the end bit, accompanying the content, are sampled. The reason will be described below.

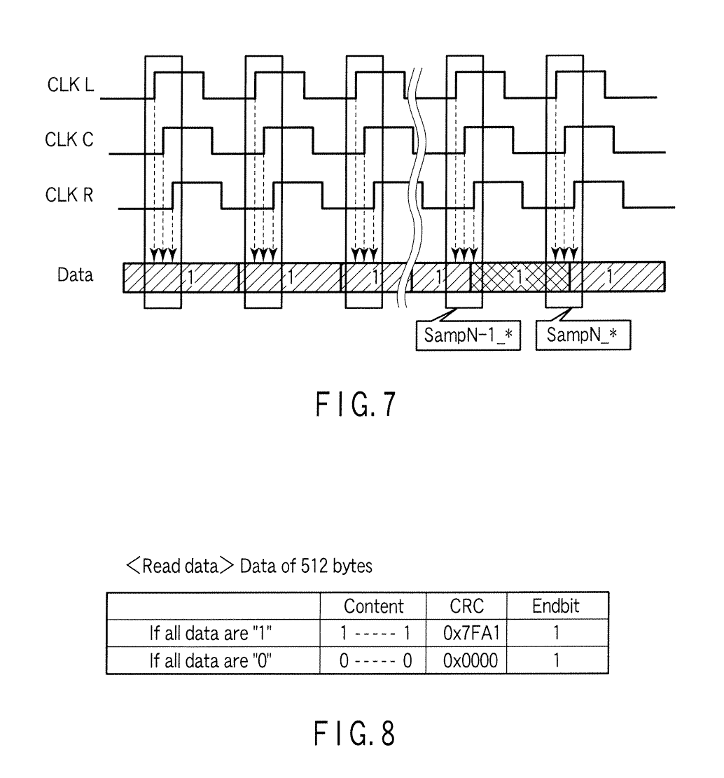

According to the conventional art, if the value of the content does not change with time (that is, if the values of all data of the content are “1”, or the values of all data are “0”), a phase shift cannot be detected. For example, if all values are “1” as shown in FIG. 7, even if a phase shift occurs at the timings corresponding to Samp_N−1 and Samp_N, the phase shift cannot be detected since all of the three sampling data values are “1”. To solve this problem, the period in which the value does not change may be counted for each of the three sampling clocks, and if the period exceeds a preset value, retuning may be performed. According to this method, however, if the values do not change, unnecessary retuning must be repeatedly carried out, even if a phase shift does not occur. As a result, the transfer efficiency will be lowered.

In this embodiment, even if the values of the content of data are the same, whether there is a phase shift or not can be detected and the phase can be corrected if there is a phase shift, in the same manner as in the case where the values of the content of data are different. Specifically, as shown in FIG. 3 and FIG. 4, not only the content of read data but also the additional information, e.g., cyclic redundancy check (CRC) information and an end bit, accompanying the content, are sampled. With this sampling, even if the values of the content are the same, a value different from the value can be obtained from the CRC information or the end bit. Therefore, a change in the value can be necessarily detected.

An example of read data of 512 bytes will be described with reference to FIG. 8.

If all values of the content are “1”, the values of CRC information are “0x7FA1” and the value of the end bit is “1”. In this case, there is a value “0” in the CRC information, which is different from the value “1” of the content.

If all values of the content are “0”, the values of CRC are “0x0000” and the value of the end bit is “1”. In this case, there is a value “1” in the end bit, which is different from the value “0” of the content data.

Thus, according to this embodiment, even if the values of the content are the same, a different value can be obtained from the CRC information or the end bit. Therefore, if there is a phase shift, the phase shift can be necessarily detected. Accordingly, it is ensured to provide timing when phase correction is necessary. Furthermore, since needless retuning is not carried out, the data transfer efficiency can be improved.

In the embodiment described above, input data are sampled with three kinds of sampling clocks of different phases, and the sampled data are compared to provide a comparison result. However, the number of kinds of sampling clocks is not limited to three. The sampling can be carried out with more than three kinds of sampling clocks.

In the embodiment described above, the host controller 2 performs read/write processing or the like with respect to the SD card 3, as shown in FIG. 2. However, the present invention is not limited to this configuration.

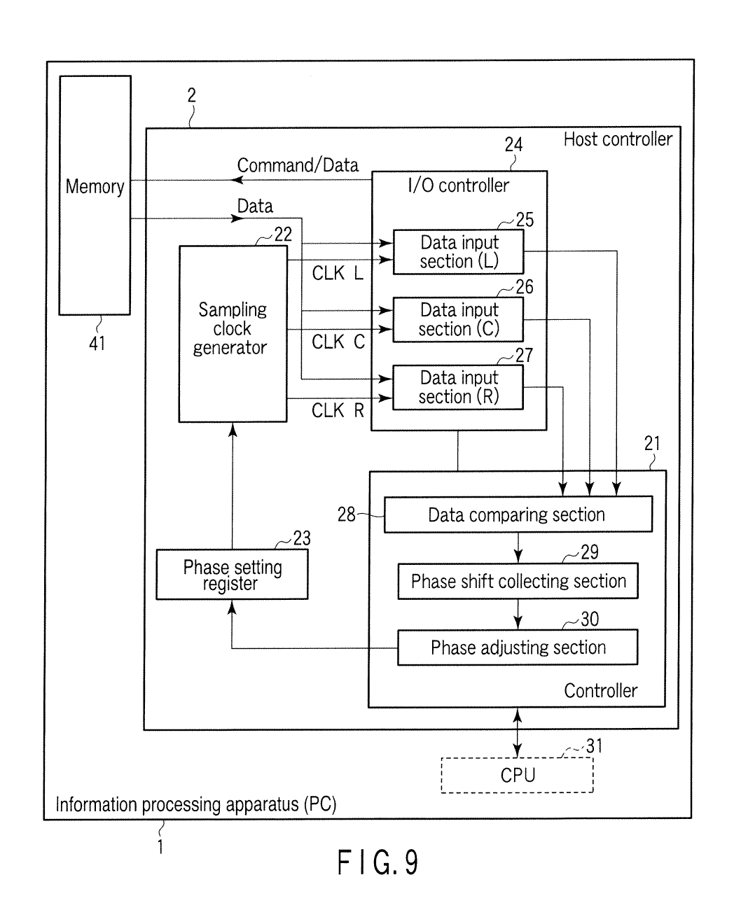

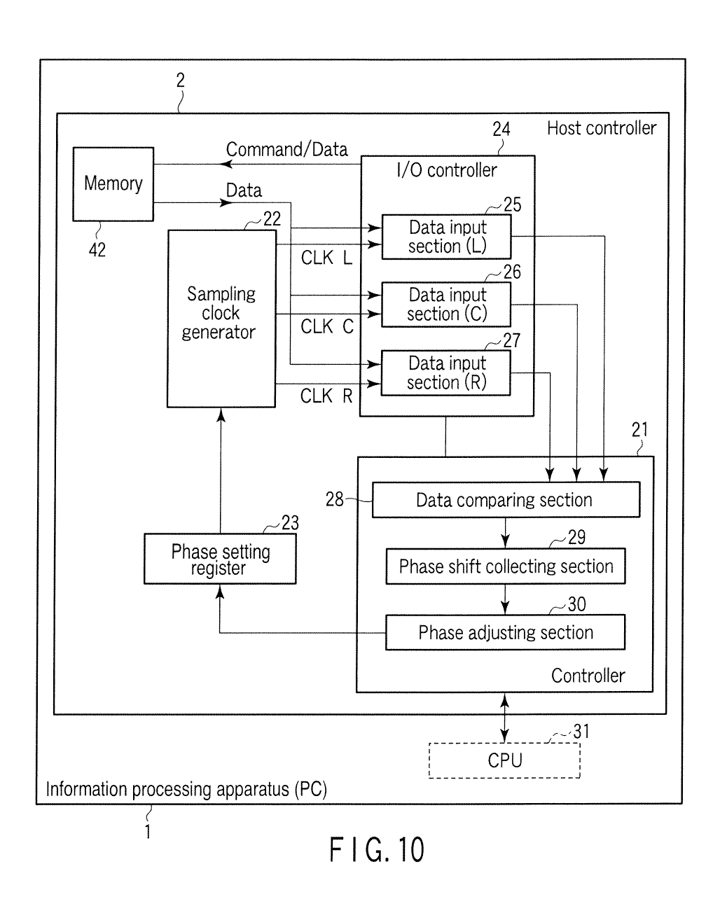

Instead of performing read/write processing or the like with respect to the SD card 3, the host controller 2 may be configured to perform read/write processing or the like with respect to, for example, a read/write memory 41 incorporated in the PC 1, as shown in FIG. 9. Alternatively, the host controller 2 may be configured to perform read/write processing or the like with respect to, for example, a read/write memory 42 incorporated in the host controller 2, as shown in FIG. 10. In either case, as well as the SD card 3, the memory 41 or 42 is a memory, which may receive a command in compliance with an SD bus protocol and transmit multiple read data based on data stored in the memory.

In the case of using the memory 41 or 42, the other configurations and the operations are the same as those of the embodiment described above.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A host controller comprising:
a plurality of data input sections configured to repeat an operation of acquiring a plurality of values by sampling a content of read data and additional information accompanying the content with a plurality of clocks of different phases; and
a controller configured to adjust phases of the clocks based on the plurality of values acquired by the data input sections.

2. The host controller of claim 1, wherein the additional information includes cyclic redundancy check (CRC) information or an end bit.

3. The host controller of claim 1, wherein the controller comprises a data comparing section configured to compare the plurality of values acquired by the data input sections; a phase shift collecting section configured to collect information relating to a phase shift of data based on a comparison result acquired from the data comparing section; and a phase adjusting section configured to adjust a phase based on a collection result acquired from the phase shift collecting section.

4. The host controller of claim 1, further comprising a phase setting register in which a phase shift amount that compensates for a phase shift is set based on a result of collection obtained from the phase shift collecting section when there is the phase shift, wherein
the phases of the clocks are adjusted according to phase setting in the phase setting register.

5. The host controller of claim 1, further comprising a memory, the read data being stored in the memory.

6. The host controller of claim 1 being implemented within an information processing apparatus that further comprises a processor configured to control the host controller.

7. The host controller of claim 6, wherein the information processing apparatus further comprises a memory, the read data being stored in the memory.

8. A semiconductor device comprising:
a plurality of data input sections configured to repeat an operation of acquiring a plurality of values by sampling a content of read data and additional information accompanying the content with a plurality of clocks of different phases; and
a controller configured to adjust phases of the clocks based on the plurality of values acquired by the data input sections.

9. The semiconductor device of claim 8, the additional information includes cyclic redundancy check (CRC) information or an end bit.

10. The semiconductor device of claim 8, wherein the controller comprises a data comparing section configured to compare the plurality of values acquired by the data input sections; a phase shift collecting section configured to collect information relating to a phase shift of data based on a comparison result acquired from the data comparing section; and a phase adjusting section configured to adjust a phase based on a collection result acquired from the phase shift collecting section.

11. The semiconductor device of claim 10, further comprising a phase setting register in which a phase shift amount that compensates for a phase shift is set based on a result of collection obtained from the phase shift collecting section when there is the phase shift, wherein
the phases of the clocks are adjusted according to phase setting in the phase setting register.

12. The semiconductor device of claim 8, further comprising a memory, the read data being stored in the memory.

13. A sampling method comprising:
repeating an operation of acquiring a plurality of values by sampling a content of read data and additional information accompanying the content with a plurality of clocks of different phases; and
detecting a shift of data relative to the clocks based on the acquired values, and adjusting the phases of the clocks based on the detected shift of the data.

14. The sampling method of claim 13, wherein the additional information includes cyclic redundancy check (CRC) information or an end bit.

15. The sampling method of claim 14, wherein the adjusting the phase includes comparing the plurality of values, collecting information relating to a phase shift of data based on a comparison result, and adjusting a phase based on a collection result.
